(19) United States
(12) Patent Application Publication
(10) Pub. No.: US 2006/0015223 A1
(43) Pub. Date: Jan. 19, 2006

(54) Communication architecture for a locomotive remote control system

(76) Inventors: Hugo LeBlanc, Rimouski (CA); Folkert Horst, Pierrefonds (CA)

Correspondence Address: NEEDLE & ROSENBERG, P.C., SUITE 1000, 999 PEACHTREE STREET, ATLANTA, GA, 30309-3915, US

(21) Appl. No.: 11/136,854

(22) Filed: May 25, 2005

Related U.S. Application Data
(60) Provisional application No. 60/574,375, filed on May 25, 2004.

(51) Int. Cl. G06F 17/00

(52) U.S. Cl. 701/19; 701/2

(57) ABSTRACT

A command unit for remotely controlling a locomotive. The command unit has a user interface for receiving user inputs and a communication interface capable of transmitting signals conveying a locomotive command derived from one or more user inputs, in at least two RF transmission modes. The communication interface includes a selector for determining in which RF transmission mode the communication interface is to transmit the signal.

### FIELD OF THE INVENTION

The invention relates to a communication architecture for a remote control system for a locomotive that allows components of the remote control system to communicate with one another in at least two different RF modes.

### BACKGROUND OF THE INVENTION

Remote control systems for locomotives are well known. For more information on this topic the reader is invited to refer to the following patent documents. The contents of those documents are incorporated herein by reference.

| Application or | | Filing Date/ |
|---|---|---|
| Patent No. | Title | Issuance Date |
| 6,449,536 | Remote Control System for | Sep. 10, 2002 |
| | Locomotives | |
| 10/201,427 | Remote Control System for | Jul. 22, 2002 |
| | Locomotives | |
| 6,466,847 | Remote Control System for a | Oct. 15, 2002 |
| | Locomotive Using Voice | |
| | Commands | |
| 6,697,716 | Remote Control System for a | Feb. 24, 2004 |
| | Locomotive Using Voice | |
| | Commands | |
| 10/328,517 | Remote Control System for a | Dec. 23, 2002 |
| | Locomotive Using Voice | |
| | Commands | |
| 09/281,464 | Method and Apparatus for | Mar. 30, 1999 |
| | Assigning Addresses to | |
| | Components in a Control | |
| | System | |
| 10/163,199 | Method and Apparatus for | Jun. 4, 2002 |
| | Assigning Addresses to | |
| | Components in a Control | |
| | System | |
| 10/163,338 | Method and Apparatus for | Jun. 4, 2002 |
| | Assigning Addresses to | |
| | Components in a Control | |
| | System | |
| 10/308,242 | Method and Apparatus for | Dec. 2, 2002 |
| | Assigning Addresses to | |
| | Components in a Control | |
| | System | |
| 6,456,674 | Method and Apparatus for | Sep. 24, 2004 |
| | Automatic Repetition Rate | |
| | Assignment in a Remote | |
| | Control System | |
| 5,511,749 | Remote Control System for a | Apr. 30, 1966 |
| | Locomotive | |
| 5,685,507 | Remote Control System for a | Nov. 11, 1997 |
| | Locomotive | |
| 6,470,245 | Remote Control System for a | |
| | Locomotive with Solid State | |
| | Tilt Sensor | |
| 6,691,005 | Remote Control System for a | Feb. 10, 2004 |
| | Locomotive with Solid State | |
| | Tilt Sensor | |
| 10/356,751 | Remote Control System for a | Jan. 30, 2003 |
| | Locomotive with Solid State | |
| | Tilt Sensor | |
| 6,693,584 | Method and Apparatus for | Feb. 17, 2004 |
| | Testing an Antenna | |
| 10/326,795 | Method and Apparatus | Dec. 20, 2002 |
| | Implementing a Communication | |
| | Protocol for Use in a Control | |
| | System | |
| 6,658,331 | Remote Control Unit for | Dec. 2, 2003 |
| | Locomotive Including Display | |
| | Module for Displaying | |
| | Command Information | |

In those systems portable command units are used to send commands to a locomotive via RF links. The integrity of the RF links is an important safety consideration and different approaches have been considered in the past to provide an efficient and low cost system, which at the same time is robust.

The objective of the present invention is to improve the existing technology is terms of efficiency and safety.

### SUMMARY OF THE INVENTION

In a first broad aspect the invention provides a command unit for remotely controlling a locomotive. The command unit has a user interface for receiving user inputs and a communication interface capable of transmitting signals conveying a locomotive command derived from one or more user inputs, in at least two RF transmission modes. The communication interface includes a selector for determining in which RF transmission mode the communication interface is to transmit the signal.

In a second broad aspect the invention provides a follower controller for mounting on-board a locomotive for causing remotely issued locomotive commands to be implemented by the locomotive. The follower controller has a communication interface capable of establishing RF communication with at least one remote command unit in at least two RF transmission modes. The communication interface includes a communication control entity for selecting one of the at least two RF transmission modes for the command unit to use for sending signals conveying locomotive commands to the follower controller.

In a third broad aspect the invention provides a follower controller for mounting on-board a locomotive for causing remotely issued locomotive commands to be implemented by the locomotive. The follower controller has a communication interface for monitoring simultaneously communications in at least two different RF modes to sense locomotive commands issued by one or more remote portable command units.

### BRIEF DESCRIPTION OF THE DRAWINGS

A detailed description of examples of implementation of the present invention is provided hereinbelow with reference to the following drawings, in which:

FIG. 1 is a block diagram of a locomotive control system using a dual mode communication architecture;

FIG. 2 is a block diagram of the locomotive control system shown in FIG. 1, where the command units and the follower controller communicate with one another in a common mode;

FIG. 3 is a block diagram of the locomotive control system shown in FIG. 1, where the command units and the follower controller communicate with one another in two different modes;

FIG. 4 is a block diagram of a command unit of the locomotive control system shown in FIG. 1;

FIG. 5 is a block diagram of a follower controller of the locomotive control system shown in FIG. 1; and

FIG. 6 is a block diagram of a repeater of the locomotive control system shown in FIG. 1;

In the drawings, embodiments of the invention are illustrated by way of example. It is to be expressly understood that the description and drawings are only for purposes of illustration and as an aid to understanding, and are not intended to be a definition of the limits of the invention.

### DETAILED DESCRIPTION

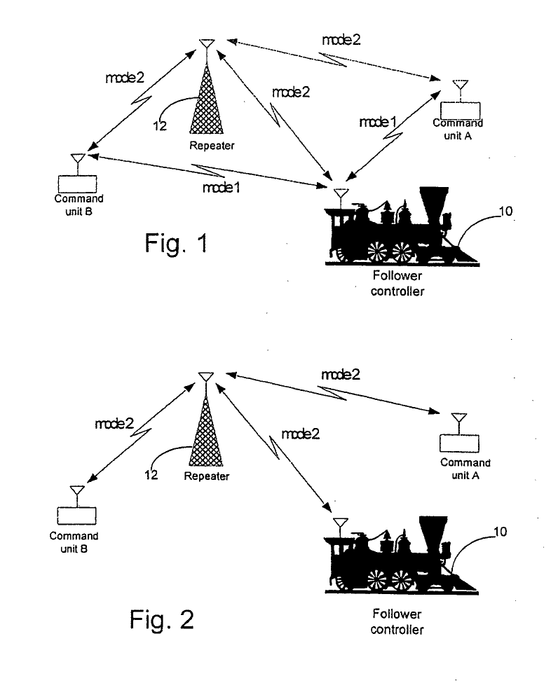

FIG. 1 is a block diagram of a remote control system for a locomotive according to a non-limiting example of implementation of the invention. The remote control system has two portable command units A and B, respectively that can send commands to a locomotive in which is mounted a follower controller 10. The follower controller receives the commands and supplies control signals to the locomotive to implement the commands. The command units A and B communicate with the follower controller 10 via Radio Frequency (RF).

In the specific example shown, the command units A and B control a single locomotive under the so called “pitch and catch” approach where active control is available to only one of the command units, while the other command unit retains some minimal degree of control for safety reasons, such the ability to stop the locomotive. The active control can be switched from one command unit to the other according to a predetermined procedure. The notion of “pitch and catch” is described in greater detail in the U.S. Pat. No. 5,687,507 granted to Canac International Inc. on Nov. 11, 1997.

It should be appreciated that the present invention is not limited to use in a “pitch and catch” environment and can be applied broadly to other applications where one or more command units issue commands to one or more locomotives via RF links.

The RF communication architecture of the remote control system shown in FIG. 1 has at least two different communication modes. The communication modes provide components of the remote control system for the locomotive with different link or channel options to pass information between them. Generally, the communication modes are independent of one another; information passing in one mode is separate and can be distinguished from information passing in another mode. Communication independence between the modes can be achieved in different ways. One possible example is to assign to each communication mode a different frequency bandwidth. In another example, when using Frequency Hopping Spread Spectrum (FHSS), each communication mode is assigned a different hopping pattern or the hopping patterns of the respective communication modes are contained in different frequency bands. In yet another possible example, when using Time Division Multiple Access each communication mode can be assigned unique sets of time slots over a common link.

In the example shown in FIG. 1, each transmission mode allows an RF communication to take place between the command units A and B, and the follower controller 10, independently of the other transmission mode. Each transmission mode is implemented by a separate RF network. The first RF network which implements the first transmission mode, designated in the drawings as “mode 1”, is a direct mode in which the individual command units A and B establish communication links directly with the follower controller 10. Those communication links are bi-directional links, although one can envisage applications where unidirectional links can be used. The second RF network that implements the second transmission mode, designated in the drawings as “mode 2” is an infrastructure mode. The infrastructure mode uses a repeater 12 as an intermediate communication component between the command units A and B and the follower controller 10. In the infrastructure mode each command unit establishes a communication link with the repeater 12, which in turn establishes a communication link with the follower controller 10. As in the case of the first RF network, the communication links are bi-directional although this is not considered an essential feature of the invention.

The first and the second RF networks are point-to-multi point networks, in that each includes a communication controller and a plurality of remote communication units. A communication controller is to be distinguished from the command units A and B. The command units A and B supply command to the follower controller 10 to be executed by the locomotive while the communication controller manages the communication process between the components of the remote control system. Accordingly, the communication controller can very well reside in a component of the remote control system that does not issue any commands to the locomotive. Specifically, in the case of the first network, the communication controller is implemented by the follower controller 10 and the command units A and B are considered as remote communication units. In the second network the communication controller is implemented by the repeater 12 and the command units A and B, and the follower controller are the remote communication units.

As indicated earlier the communication controller manages the communication process in a given RF network. For example, when the RF network uses Frequency Hopping Spread Spectrum (FHSS) the communication controller will regulate the bandwidth (or airtime) attribution to ensure no conflicts between the entities communicating in the RF network. In a possible variant the RF network can use Time Division Multiple Access (TDMA) in which case the communication controller will be responsible of time slot assignments, among others.

FIG. 4 is a block diagram of the command unit A. The structure of the command unit B is the same and it will not be described separately. The command unit A has a user interface 14 for receiving user inputs that can be resolved into locomotive commands. The user interface 14 may include a keypad or keyboard, manually operable switches or levers, a touch sensitive screen, pointer devices or voice recognition. In addition the user interface 14 may also include an information delivery device to the user to communicate to the user system status information, alarms, etc. The information delivery device can be visual, such as a display screen or auditory such as a text to speech synthesizer.

The command unit A further includes a control unit 16 that receives the user inputs entered at the user interface 14. The control unit 16 has a global controlling function, in particular it generates on the basis of the user inputs at the user interface 14 the actual messages that are to be sent to the locomotive and that contain locomotive commands. For example, a locomotive command may require the locomotive to move forwards or backwards at a certain speed, may require the locomotive to brake, among others.

The message conveying the locomotive command is issued by the control unit 16 in digital form and supplied to the communication interface 18. The communication interface 18 has a transmission section for transmitting RF signals and a receiver section for receiving RF signals. A selector 20 determines in which RF network the transmitter section and the receiver section will transmit and receive, respectively by changing their operational parameters. In a specific example of implementation the selector is implemented in software but it can also be envisaged to implement it in hardware or partially in software and hardware.

The selector 20 uses logic that determines when the transmitter section and the receiver section will switch from one RF network to the other RF network. One parameter that the selector 20 uses to switch the RF communication from one RF network to the other RF network is the occurrence of a predetermined operational condition. In one possible example, the operational condition is a low likelihood of reception of the commands sent by the command unit A by the follower controller 10. When the likelihood of reception is low, the logic in the selector 20 concludes that the communication in the current RF network is no longer reliable and will direct the transmitter section and the receiver section to switch to the second RF network. Determining that the likelihood of reception is low can be done in several ways. In the case of bi-directional communication links, the receiver section monitors signals sent by the follower controller 10 to the command unit A that acknowledge reception of the locomotive commands sent by the command unit A. When no acknowledgements are being received the logic concludes that the locomotive commands have not been properly received and it concludes that the likelihood of command reception is low.

The strategy that can be implemented by the selector 20 when it determines that the likelihood of command reception is low is to automatically perform an RF network switch which includes starting transmitting commands in the other RF network. At this point the selector 20 waits to determine if the commands have been properly received by the follower controller 10. If the selector 20 senses command acknowledgements, it determines that the commands are now properly receives and continues to transmit in the current RF network. If no acknowledgements are received within a predetermined time period, the selector 20 will switch back to the original RF network and transmit there for a predetermined time period. The RF network switching will continue until proper command reception has been established in one of the RF networks. At this point any further transmission will be effected in that RF network.

Another possibility of detecting a low likelihood of command reception is to monitor the quality of the link from the follower controller 10 to the command unit A. When the error rate exceeds a threshold, the logic in the selector 20 determines that the quality of the link is poor and assumes a low likelihood of command reception. The error rate can be the frame error rate on the link. Another possible method of determining the link quality is by using a Receive Signal Strength Indicator (RSSI). The RSSI indicator is an analog indicator that provides a measure of the RF signal strength. In the case communication via the first RF network (mode 1) the monitoring of the quality of the link is done directly since the communication link is established between the follower controller 10 and the command unit A with no intermediary. In the case of communication via the second RF network, the monitoring of the quality of the link is an indirect measure since the communication link that is being observed includes an intermediary component, namely the repeater 12.

The operational condition can also be the reception of a direct command from the follower controller 10 to switch RF networks. This is implemented by designing the follower controller 10 to send an explicit directive to the command unit A to start using the other RF network.

It should be appreciated that in the example described above, the communication interface 18 cannot communicate at the same time in both RF networks and can only communicate in one RF network at a time.

In the specific example of FHSS communication, both RF networks can be designed to work in FHSS, however the frequency hopping pattern is different for each RF network to avoid interference. The selector 20 effects RF network switching by tracking and synchronizing with the frequency hopping pattern of the new RF network in which communications are to be established and once this synchronization is effected, any further communication happens in the new RF network.

FIG. 5 is a high level block diagram of the repeater 12. The repeater 12 has a communication interface 22 which can be designed to work exclusively in mode 2, i.e. the second RF network that corresponds to the infrastructure mode. The communication interface 22 works in FHSS and the repeater 12 is the communication controller for the second RF network. The command units A and B and the follower controller 10 are communication remote units. It should be appreciated that for simplicity the block diagram of the repeater 12 does not show the remainder of the repeater functionality and structure.

FIG. 6 is a high level block diagram of the follower controller 10. The follower controller 10 includes a communication interface 24 that is linked to a control unit 26. The control unit 26 receives the command information in the signals conveying locomotive commands and picked up by the communication interface and issues local control signals, designated by the arrow 28 which are relayed to the appropriate locomotive controls, such as throttle and brake, among others, to implement the locomotive commands.

The communication interface 24 has two separate units. The first unit is part of the first RF network (mode 1), while the second unit is part of the second RF network (mode 2). The first and second units are largely independent and include respective transmitter and receiver sections. Accordingly, the communication interface 24 can communicate simultaneously in both RF networks. The second unit of the communication interface 24 is a remote communication unit (the repeater 12 is the communication controller), while the first unit of the communication interface 24 is the communication controller of the first RF network (mode 1).

The communication interface 24 includes logic 30 that can track in which RF networks the command units A and B are, such that when information is to be sent to any one of the command units A and B, it will be transmitted in the proper RF network. This functionality can be implemented as a simple data structure that is updated every time a switch from one RF network to the other RF network is made.

In addition, the logic 30 also can assess the link quality or determine on the basis of reported link quality information if an RF network switch is required.

The logic 30 can directly assess link quality in the following two cases:

1. In the fist RF network, determine the error rate, such as the frame error rate when communicating with either one of the command units A or B. When the error rate exceeds a given level the link is deemed to be of low quality and the logic 30 issues directs the communication interface 24 to issue a command to the respective command unit A or B to switch RF networks. Another possible method of determining the link quality is by using the RSSI method. It should be appreciated that the link quality determination is made on a channel by channel basis, in other words it is done independently for each command unit. For instance, a situation may arise when the link quality from command unit A to the follower controller 10 is assessed to be low and requires switching to the second RF network, while the link quality from command unit B to the follower controller is satisfactory and can be maintained in the first RF network. After the switch the command units A and B will continue communicating with the follower controller but in different RF networks.

2. In the second RF network determine the error rate, such as the frame error rate on the link between the repeater 12 and the follower controller 10. When the error rate exceeds a given level the link is deemed to be of low quality and the logic 30 issues a command to both command units A or B to switch to the first RF network. Another possible method of determining the link quality is by using the RSSI measurement.

The logic 30 can make decisions on which RF network to use on the basis of reported link quality information in the following instances:

1. In the first RF network, each command unit is designed to assess the quality of the link from the follower controller 10 to the command unit by any one of the ways described earlier, such as by measuring the frame error rate or by using the RSSI indicator. The assessed link quality information is then sent to the follower controller 10 over the link. Of course, this assumes that the link is still functional and can convey this information. The logic 30 treats this information in the same way as in the case where the link quality is measured by the follower controller. When the link quality is below a certain limit, the logic 30 directs the communication interface 24 to send to the command unit a directive to switch RF networks.

2. In the second RF network, each command unit can assess the quality of the link from the repeater 12 to the command unit, again by any one of the methods described earlier. The assessed link quality information is then passed to the follower controller and the logic 30 in the follower controller determines if an RF network switch should be made.

The above examples of implementation measure the link quality on the basis of frame error rate or RSSI. It should be expressly noted that other ways of determining the link quality can be used without departing from the spirit of this invention.

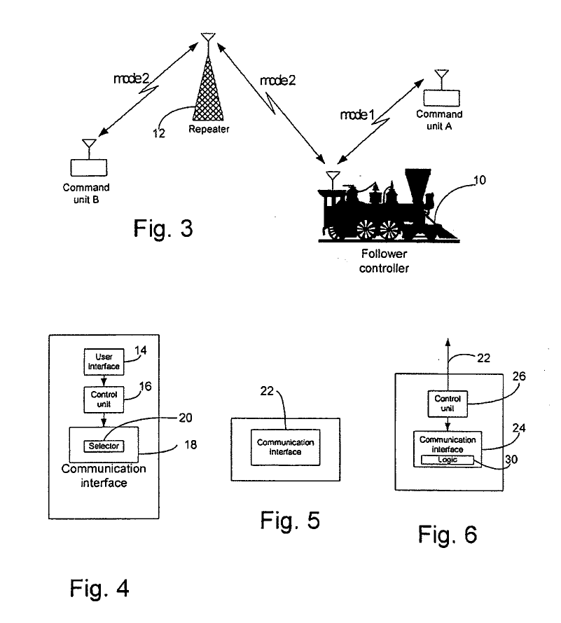

FIG. 2 illustrates an example of operation of the remote control system for the locomotive where all communications take place in the second RF network (mode 2). FIG. 3 shows an example of operation where command unit B is in the second RF network while command unit A has switched to the first RF network.

Although various embodiments have been illustrated, this was for the purpose of describing, but not limiting, the invention. Various modifications will become apparent to those skilled in the art and are within the scope of this invention, which is defined more particularly by the attached claims.

1) A portable command unit for remotely controlling a locomotive, comprising:
a) a user interface for receiving user inputs;
b) a communication interface capable of transmitting signals conveying a locomotive command derived from one or more user inputs, in at least two RF transmission modes, said communication interface including a selector for determining in which RF transmission mode of said at least two transmission modes said communication interface is to transmit the signal.

2) A portable command unit as defined in claim 1, wherein the at least two transmission modes include a first transmission mode and a second transmission mode, the first transmission mode being implemented by a first RF network, the second transmission mode being implemented by a second RF network.

3) A portable command unit as defined in claim 2, wherein the first RF network has a communication controller and a plurality of communication remote units.

4) A portable command unit as defined in claim 3, wherein the second RF network has a communication controller and a plurality of communication remote units.

5) A portable command unit as defined in claim 3, wherein the communication controller of the first RF network establishes communication links with respective ones of the communication remote units of the first RF network.

6) A portable command unit as defined in claim 5, wherein the communication links are bi-directional links.

7) A portable command unit as defined in claim 5, wherein the communication controller of the second RF network establishes communication links with respective ones of the communication remote units of the second RF network.

8) A portable command unit as defined in claim 7, wherein the communication links are bi-directional links.

9) A portable command unit as defined in claim 2, wherein the first RF network uses a communication method selected in the group consisting of spread spectrum and TDMA.

10) A portable command unit as defined in claim 2, wherein the first RF network uses FHSS.

11) A portable command unit as defined in claim 2, wherein the second RF network uses a communication method selected in the group consisting of spread spectrum and TDMA.

12) A portable command unit as defined in claim 2, wherein the second RF network uses FHSS.

13) A portable command unit as defined in claim 2, wherein said selector directs said communication interface to switch communication from the first RF network to the second RF network when said selector determines that a predetermined operational condition has occurred.

14) A portable command unit as defined in claim 13, wherein said predetermined operational condition includes a low likelihood of reception of the locomotive command conveyed via the first RF network.

15) A portable command unit as defined in claim 14, wherein said communication interface can receive acknowledgement messages from the locomotive, said selector determines that the likelihood of reception of the locomotive command is low when no acknowledgement messages are received by said communication interface.

16) A portable command unit as defined in claim 14, wherein said selector monitors a quality of a link in the first RF network to detect an occurrence of a low likelihood of reception of the locomotive command.

17) A portable command unit as defined in claim 16, wherein said selector monitors the quality of the link from the locomotive to said portable command unit to detect an occurrence of a low likelihood of reception of the locomotive command.

18) A portable command unit as defined in claim 17, wherein said selector monitors the quality of the link by measuring an error rate on the link.

19) A portable command unit as defined in claim 18, wherein the error rate is a frame error rate.

20) A portable command unit as defined in claim 17, wherein said selector monitors the quality of the link by measuring the RSSI.

21) A portable command unit as defined in claim 13, wherein said predetermined operational condition includes reception of a command from a follower controller mounted on the locomotive to switch communication from the first RF network to the second RF network.

22) A portable command unit as defined in claim 2, wherein said selector is capable of determining a quality of a link established between said portable command unit and a remote entity in the first RF network.

23) A portable command unit as defined in claim 22, wherein the remote entity includes a repeater.

24) A portable command unit as defined in claim 22, wherein the remote entity includes the locomotive.

25) A portable command unit as defined in claim 22, wherein said selector directs said communication interface to convey quality of link information derived from the determining to a remote component, via one of the first or second RF networks.

26) A portable command unit as defined in claim 25, wherein the remote component includes the locomotive.

27) A portable command unit for remotely controlling a locomotive, comprising:
a) user interface means for receiving user inputs;
b) a communication interface means capable of transmitting signals conveying a locomotive command derived from one or more user inputs, in at least two RF transmission modes, said communication interface including a selector means for determining in which RF transmission mode of said at least two transmission modes said communication interface means is to transmit the signal.

28) A follower controller for mounting on-board a locomotive for causing remotely issued locomotive commands to be implemented by the locomotive, said follower controller comprising:
a) a communication interface capable of establishing RF communication with at least one remote portable command unit in at least two RF transmission modes;
b) said communication interface including a communication control entity for selecting one of the at least two RF transmission modes for the portable command unit to use for sending signals conveying locomotive commands to said follower controller.

29) A follower controller as defined in claim 28, wherein the at least two transmission modes include a first transmission mode and a second transmission mode, the first transmission mode being implemented by a first RF network, the second transmission mode being implemented by a second RF network.

30) A follower controller as defined in claim 29, wherein said communication control entity is operative to send a message to the portable command unit to indicate which of the at least two RF transmission modes the command unit is to use for sending the signals conveying locomotive commands to said follower controller.

31) A follower controller as defined in claim 30, wherein said communication control entity is capable of receiving information via the first RF network or the second RF network on a quality of a communication link established between two components in the first RF network or in the second RF network.

32) A follower controller as defined in claim 31, wherein said communication control entity is capable of receiving information from the remote portable command unit on a quality of a link between the remote portable command unit and said follower controller.

33) A follower controller as defined in claim 31, wherein said communication control entity is capable of receiving information from the remote portable command unit on a quality of a link between the remote portable command unit and a repeater.

34) A follower controller as defined in claim 31, wherein said communication control entity is capable of receiving information from a repeater in the first or in the second RF networks on a quality of a link between the repeater and said follower controller.

35) A follower controller as defined in claim 31, wherein said communication control entity sends the message at least in part on a basis of the information on the quality of the link between established between the two components in the first RF network or in the second RF network.

36) A follower controller as defined in claim 29, wherein the first RF network has a communication controller and a plurality of communication remote units.

37) A follower controller as defined in claim 29, wherein the second RF network has a communication controller and a plurality of communication remote units.

38) A follower controller for mounting on-board a locomotive for causing remotely issued locomotive commands to be implemented by the locomotive, said follower controller comprising:
a) a communication interface means capable of establishing RF communication with at least one remote portable command unit in at least two RF transmission modes;
b) said communication interface means including a communication control entity means for selecting one of the at least two RF transmission modes for the portable command unit to use for sending signals conveying locomotive commands to said follower controller.

39) A follower controller for mounting on-board a locomotive for causing remotely issued locomotive commands to be implemented by the locomotive, said follower controller comprising a communication interface capable of:
a) establishing RF communication with a first remote portable command unit in a first RF transmission mode for receiving locomotive commands; and
b) establishing RF communication with a second remote portable command unit in a second RF communication mode for receiving locomotive commands.

40) A follower controller as defined in claim 39, wherein said follower controller includes a control unit in communication with said communication interface, said control unit being responsive to reception of the locomotive commands from the first remote portable command unit and from the second remote portable command unit for causing implementation of the locomotive commands by the locomotive.

41) A follower controller as defined in claim 40, wherein the at least two transmission modes include a first transmission mode and a second transmission mode, the first transmission mode being implemented by a first RF network, the second transmission mode being implemented by a second RF network.

42) A follower controller as defined in claim 41, wherein the first RF network has a communication controller and a plurality of communication remote units.

43) A follower controller as defined in claim 42, wherein the second RF network has a communication controller and a plurality of communication remote units.

44) A follower controller for mounting on-board a locomotive for causing remotely issued locomotive commands to be implemented by the locomotive, said follower controller comprising:
a) communication interface means for:
i) establishing RF communication with a first remote portable command unit in a first RF transmission mode for receiving locomotive commands; and
ii) establishing RF communication with a second remote portable command unit in a second RF communication mode for receiving locomotive commands; and
b) a control unit in communication with said communication interface means, said control unit being responsive to reception of the locomotive commands from the first remote portable command unit and from the second remote portable command unit for causing implementation of the locomotive commands by the locomotive.

45) A follower controller for mounting on-board a locomotive for causing remotely issued locomotive commands to be implemented by the locomotive, said follower controller comprising a communication interface for monitoring simultaneously communications in at least two different RF modes to sense locomotive commands issued by one or more remote portable command units.
